(19) United States
(12) Patent Application Publication
(10) Pub. No.: US 2026/0269496 A1
(43) Pub. Date: Sep. 10, 2026

(54) CONNECTOR AND CONNECTOR ASSEMBLY COMPRISING SAME

(71) Applicant: LS MTRON LTD., Anyang-si, Gyeonggi-do (KR)

(72) Inventor: Sang Jun OH, Anyang-si, Gyeonggi-do (KR)

(21) Appl. No.: 18/871,754

(22) PCT Filed: Jul. 13, 2023
(86) PCT No.: PCT/KR2023/010018

§ 371 Date: Dec. 4, 2024

(30) Foreign Application Priority Data
Oct. 14, 2022 (KR) 10-2022-0132033
Jun. 23, 2023 (KR) 10-2023-0081016

(51) Int. Cl. H01R 12/70; H01R 12/71; H01R 13/24; H01R 13/504

(52) U.S. Cl. CPC H01R 12/7082; H01R 12/714; H01R 12/716; H01R 13/24; H01R 13/504

(57) ABSTRACT

A receptacle connector is provided. The receptacle connector according to one aspect of the present disclosure comprises: an insulating body which includes a flat bottom portion a pair of outer support wall portions protruding from the bottom portion and extending in parallel to each other in a first direction (x-axis direction), and a pair of inner support wall portions that are provided between the pair of outer support wall portions and extend in parallel, and which can be placed on a substrate; a plurality of first contacts disposed on each of the pair of outer support wall portions so as to be spaced apart from each other in the first direction (x-axis direction); and a plurality of second contacts each disposed between neighboring first contacts in the first direction (x-axis direction) from among the plurality of first contacts wherein the pair of inner support wall portions are spaced apart from each other in a second direction (y-axis direction) so that one portion of another connector can enter therebetween.

### CROSS-REFERENCE TO RELATED APPLICATION

This application is a National Stage of International Application No. PCT/KR 2023/010018, filed Jul. 13, 2023, which claims priority to and the benefit of Korean Patent Application No. 10-2022-0132033, filed Oct. 14, 2022, and Korean Patent Application No. 10-2023-0081016, filed Jun. 23, 2023, the disclosures of which are incorporated herein by reference in its entirety.

### FIELD

The present disclosure relates to a connector, and more particularly, to a connector, which may be mounted on the substrate and a connector assembly including the same.

### BACKGROUND

In general, a connector is provided in various electronic devices for electrical connection. For example, the connector may be installed in an electronic device such as a mobile phone, a computer, a tablet computer, or the like, and may electrically connect various components installed in the electronic device to each other. Such a connector includes an insulating body placed on a substrate, and a plurality of contacts arranged in parallel to each other along one direction on the insulating body.

In this case, as a method for increasing the number of contacts of the connector, it may be considered to densely arrange the contacts in the insulating body by increasing the size of the insulating body on which the contacts are placed or by narrowing the distance (i.e., pitch) between the contacts.

However, if the first method of the above-described method is applied to the conventional connector, the size of the insulating body may be excessively long or large as the number of contacts increases, thereby limiting the degree of freedom in designing a substrate circuit, causing defects in manufacturing due to bending, and lowering the overall strength of the connector.

If the second method of the above-described method is applied to the conventional connector, there is a problem that the insulation performance between the two contacts is not secured as the neighboring contacts become closer to the portion coupled to the substrate, and a short circuit may occur.

Accordingly, there has been a demand for development of a connector capable of minimizing the pitch so that many contacts may be arranged in a limited space without causing the above-described insulating problem.

### SUMMARY

The present disclosure has been devised in consideration of the above points, and it is an object of the present disclosure to provide a connector capable of minimizing a pitch between contacts and a connector assembly including the same.

Another object of the present disclosure is to provide a connector capable of electrically connecting (or in contact) with other connectors with high stability, and a connector assembly including the same.

Another object of the present disclosure is to provide a connector having a strong rigidity (or strength) and a connector assembly including the same.

Another object of the present disclosure is to provide a connector capable of being easily and quickly manufactured in a simple process and a connector assembly including the same.

The technical problems of the present disclosure are not limited to the above-mentioned technical problems, and other technical problems not mentioned may be clearly understood by those skilled in the art to which the present disclosure pertains from the following description.

According to an aspect of the present disclosure, there is provided a receptacle connector 20 including: an insulating body 500 configured to be placed on a substrate, including: a flat plate-shaped bottom 510, a pair of outer support walls 520 configured to protrude from the bottom 510 and extend in parallel to each other in a first direction (X-axis direction), and a pair of inner support walls 540 configured to extend in parallel between the pair of outer support walls 520; a plurality of first contacts 600 configured to be disposed apart from each other along the first direction (X-axis direction) on each of the pair of outer support walls 520; and a plurality of second contacts 700 each configured to be respectively disposed between the first contacts 600 adjacent to each other in the first direction (X-axis direction) among the plurality of first contacts 600, wherein the pair of inner support walls 540 are configured to be spaced apart each other in a second direction (Y-axis direction) so that a coupling space 511 for receiving a portion of another connector is provided between the pair of inner support walls 540.

In this time, the insulating body 500 may include an inner wall 550 configured to be provided at each of one end of the pair of inner support walls 540 in an extension direction and connect the one ends of the pair of inner support walls 540 to each other, and the inner wall 550 may be provided in a pair and the pair of the inner walls are configured to be respectively disposed at both ends of the pair of inner support walls 540 in the extension direction.

In this time, each of the first contacts 600 may be configured to be provided as a fixed terminal, including: a first outer coupler 610 configured to be coupled to the outer support wall 520 so that at least a portion thereof is exposed to the outside, a first inner coupler 620 configured to be connected to the first outer coupler 610 and be coupled to the inner support wall 540 so that at least a portion thereof is exposed to the outside, and a first substrate mounter (Clean Version) 640 configured to extend from one side of the first inner coupler 620 to a space between the pair of inner support walls 140 and be mounted on the substrate, and each of the second contacts 700 may be configured to be provided as a movable terminal, including: a second outer coupler 710 configured to be coupled to the outer support wall 520 so that at least a portion thereof is exposed to the outside, and an elastic contactor 720 configured to extend from one side of the second outer coupler 710 onto a side surface 544 of the inner support wall 540 and have a free end to be elastically operated by being pressurized by an external force.

In this time, each of the first contacts 600 may include a carrier connector 650 configured to extend in a direction opposite to the first substrate mounter 640 from the first outer coupler 610, and the carrier connector 650 may include a plating layer L so that a side surface 652 in the extension direction is configured to be not exposed to the outside, and an end surface 654 in the extension direction is configured to be exposed to the outside.

In this time, each of the second contacts 700 may include a second substrate mounter 740 configured to extend from the other side of the second outer coupler 710 in a direction opposite to the first substrate mounter 640 and be mounted on the substrate.

In this time, the coupling space 511 may penetrate the bottom 510 so that the first substrate mounter 640 may be observed through the coupling space 511.

In this time, the coupling space 511 may extend along the first direction X-axis direction so that at least two of the first substrate mounters 640 may be observed.

According to another aspect of the present disclosure, there is provided a plug connector 10 for coupling with the aforementioned receptacle connector 20, including an insulating body 100 configured to be placed on a substrate, including: a flat plate-shaped bottom 110, a pair of outer support walls 120 configured to protrude from the bottom 510 and extend in parallel to each other in a first direction (X-axis direction), and an inner support wall 140 configured to extend in parallel between the pair of outer support walls 120; a plurality of first contacts 200 configured to be disposed apart from each other along the first direction (X-axis direction) on each of the pair of outer support walls 120; and a plurality of second contacts 300 configured to be respectively disposed between the first contacts 200 adjacent to each other in the first direction (X-axis direction) among the plurality of first contacts 200, wherein the inner support wall 140 is configured to have a shape to be inserted into the coupling space 511 of the receptacle connector 20 so as to be coupled between the pair of inner support walls 540 of the receptacle connector 20.

In this time, each of the first contacts 200 may be provided as a fixed terminal, including: a first outer coupler 210 configured to be coupled to the outer support wall 220 so that at least a portion thereof is exposed to the outside, and a first substrate mounter 220 configured to extend from one side of the first outer coupler 210 to the inner support wall 140 and be mounted on the substrate, and each of the second contacts 300 may be provided as a movable terminal, including: a second outer coupler 310 configured to be coupled to the outer support wall 120 so that at least a portion thereof is exposed to the outside, and an elastic contactor 320 configured to extend from one side of the second outer coupler 310 onto a side surface 142 of the inner support wall 140 and have a free end to be elastically operated by being pressurized by an external force.

In this time, the first outer coupler 210 may include a first inner contact section 214 configured to be coupled onto a first side surface 122 facing the inner support wall 140 among both side surfaces 122 and 124 of the outer support wall 120 so that at least a portion thereof is exposed to the outside; a first outer contact section 212 configured to be coupled onto a second side surface 124 opposite the first side surface 122 among both side surfaces 122 and 124 of the outer support wall 120 so that at least a portion thereof is exposed to the outside; and a first outer connection section 216 configured to connect the first inner contact section 214 and the first outer contact section 212, wherein the first substrate mounter 220 may extend from the first inner contact section 214.

In this time, the first substrate mounter 220 may be at least partially exposed to the outside of the bottom 110, and the bottom 110 may be provided with an inspection window 111 for viewing the exposed portion of the first substrate mounter 220 to the outside of the bottom 110.

In this time, each of the first contacts 200 may include a carrier connector 230 configured to extend in a direction opposite to the first substrate mounter 220 from the first outer contact section 212, and the carrier connector 230 may include a plating layer L so that a side surface 232 in the extension direction is configured to be not exposed to the outside, and an end surface 234 in the extension direction is configured to be exposed to the outside.

In this time, each of the second contacts 300 may include a second substrate mounter 340 configured to extend from the other side of the second outer coupler 310 in a direction opposite to the first substrate mounter 220 and be coupled with the substrate.

In this time, the side surface 142 of the inner support wall 140 may be provided with a concave groove 143 recessed inwardly to provide a space in which the elastic contactor 320 may elastically operate.

In this time, the first contacts 200 provided on one of the pair of outer support walls 120 and the second contacts 300 provided on the other of the pair of outer support walls 120 may be arranged in parallel to each other in a direction in which the pair of outer support walls 120 is arranged (Y-axis direction).

According to another aspect of the present disclosure, there is provided a connector assembly 1 used with a plug connector 10 and a receptacle connector 20 coupled to each other, and the plug connector 10 may include a first insulating body 100 including: a first bottom 110 having a flat-plate shape, a pair of first outer support wall 120 configured to protrude from the first bottom 110 and extend in parallel to each other along a first direction (X-axis direction), a pair of first hold down retaining walls 130 configured to be provided at both ends of the pair of first outer support walls 120 in the extension direction, respectively, and a first inner support walls 140 configured to extend in parallel between the pair of first outer support walls 120; and a plurality of contacts 200 and 300 configured to be spaced apart from each other along the first direction (X-axis direction) on each of the pair of first outer support walls 120, and the receptacle connector 20 may include a second insulating body 500 including: a second bottom 510 configured to be spaced apart from the first bottom 110 to face each other, a pair of second outer support wall 520 configured to protrude from the second bottom 510 and extend in parallel to each other along the first direction (X-axis direction), a pair of second hold down retaining walls 530 configured to be provided at both ends of the pair of second outer support wall 520 in the extension direction, respectively, a pair of second inner support wall 540 configured to extend in parallel between the pair of second outer support wall 520 and be provided with a coupling space 511 therebetween, and a pair of second inner walls 550 configured to be provided at both ends of the pair of second inner support walls 540 in the extension direction, respectively; and a plurality of contacts 600 and 700 configured to be spaced apart from each other along the first direction (X-axis direction) on each of the pair of outer support walls 520, respectively, wherein the coupling of the plug connector 10 and the receptacle connector 20 is configured to be achieved by the first inner support wall 140 of the plug connector 10 entering the coupling space 511 of the receptacle connector 20.

In this time, the plug connector 10 may include a first hold down structure 400 configured to cover both side surfaces of the first hold down retaining wall 130, and the receptacle connector 20 may include a second hold down structure 800 covering one side surface facing the second inner wall 550 among both side surfaces of the second hold down retaining wall 530 and one side surface facing the one side surface of the second hold down retaining wall 530 among both side surfaces of the second inner wall 550.

In this time, a first direction (X-axis direction) distance d1 between an end surface 144 of the first inner support wall 140 in the X-axis direction and one side surface 552 of the second inner wall 550 facing the end surface 144 may be configured to be longer than a first direction (X-axis direction) distance d2 between one side surface 422 facing the second inner wall 550 among both side surfaces of the first direction (X-axis direction) of the first hold down structure 400 and one side surface 842 of the second hold down structure facing the one side surface 422 of the first hold down structure 400.

In this time, a first direction (X-axis direction) distance d2 between the one side surface 422 of the first hold down structure 400 and the one side surface 842 of the second hold down structure 800 may be configured to be longer than a first direction (X-axis direction) distance d3 between the other side surface 432 facing the one side surface 422 of the first hold down structure 400 and the other side surface 822 of the second hold down structure 800 facing the other side surface 432 of the first hold down structure 400.

The connectors 10 and 20 according to an aspect of the present disclosure may minimize the pitch in the first direction (X-axis direction) between the contacts 200, 300, 600 and 700 because the substrate mounters 220 and 640 of the first contacts 200 and 600 and the substrate mounters 340 and 740 of the second contacts 300 and 700 extend in opposite directions to allow the distance between the substrate mounters 220, 340, 640 and 740 to be spaced apart in the second direction (Y-axis direction).

The connectors 10 and 20 according to an aspect of the present disclosure are configured such that the inner contactor (or the inner contact section) and the outer contactor (or the outer contact section) of the contacts 200, 300, 600 and 700 are provided on the side surfaces of the support walls 120, 140, 520 and 540, respectively, and may be dual contacted with the contacts 200, 300, 600 and 700 of another connectors 10 and 20, and thus may be electrically connected (or in contact) with another connectors 10 and 20 with high stability.

The connectors 10 and 20 according to an aspect of the present disclosure are configured such that the contacts 200, 300, 600 and 700 are mounted on both sides of the outer support surfaces 120 and 520 and/or the inner support surfaces 140 and 540, respectively, and thus may have strong rigidity (or strength) against an external force.

The connectors 10 and 20 according to an aspect of the present disclosure are configured such that the carrier connectors 230 and 650 of the first contacts 200 and 600 and the second substrate mounters 340 and 740 of the second contacts 300 and 700 extend to the outside of the insulating body 100 and 500, and so that the first contacts 200 and 300 and the second contacts 600 and 700 may be provided on one carrier C, and thus the insulating bodies 100 and 500 may be formed at once, so that it may be easily and quickly manufactured through a simple process.

The connector assembly 1 according to an aspect of the present disclosure is configured such that the inner support wall 140 of the first connector 10 is shape-fitted to the coupling space 511 of the second connector 20, and thus the contacts 200 and 300 of the first connector 10 and the contacts 600 and 700 of the second connector 20 may stably maintain electrical connection (or energized) and may also have strong rigidity (or strength) against the external force.

The effects of the present disclosure are not limited to the above-described effects, and the effects that are not mentioned may be clearly understood by those skilled in the art from the present specification and the accompanying drawings.

### BRIEF DESCRIPTION OF THE DRAWINGS

FIGS. 1 and 2 are perspective views of a connector according to an embodiment of the present disclosure viewed from different angles.

FIG. 3 is a plan view of a connector according to an embodiment of the present disclosure.

FIG. 4 is a plan view of a PCB pattern formed between a connector and a substrate according to an embodiment of the present disclosure.

FIG. 5 is a cross-sectional view taken along the cutting line I-I of FIG. 3.

FIG. 6 is a perspective view of a first contact of a connector according to an embodiment of the present disclosure viewed from above.

FIG. 7(a) and 7(b) are perspective views of a second contact according to an embodiment of the present disclosure viewed from different angles.

FIGS. 8 and 9 are perspective views of a connector according to another embodiment of the present disclosure, viewed from different angles.

FIG. 10 is a plan view of a connector according to another embodiment of the present disclosure.

FIG. 11 is a plan view of a PCB pattern formed between a connector and a substrate according to another embodiment of the present disclosure.

FIG. 12 is a cross-sectional view taken along the cutting line II-II of FIG. 10.

FIG. 13 is a perspective view of a first contact of a connector according to another embodiment of the present disclosure, viewed from above.

FIG. 14(a) and 14(b) are perspective views of a second contact according to another embodiment of the present disclosure, viewed from different angles.

FIG. 15 is an exploded perspective view of a connector assembly according to an embodiment of the present disclosure.

FIG. 16 is a perspective view of a connector assembly according to an embodiment of the present disclosure, viewed from above.

FIG. 17 is a cross-sectional view taken along the cutting line III-III of FIG. 16.

FIG. 18 is a cross-sectional view taken along the cutting line IV-IV of FIG. 16.

### DETAILED DESCRITION

The words and terms used in the specification and claims should not be interpreted as limited to the usual or dictionary meaning, but should be interpreted as meaning and concept consistent with the technical idea of the present disclosure in accordance with the principle in which the inventor can define the terms and concepts in order to best explain their disclosure.

In this specification, it should be understood that the terms such as “include” or “have” are intended to describe the presence of features, numbers, steps, operations, components, parts or combinations thereof described in the specification, and do not exclude the presence or addition of one or more other features, numbers, steps, operations, components, parts or combinations thereof.

The fact that a component is in the “front”, “rear”, “upper” or “lower” of another component includes not only the case that it is disposed in the “front”, “rear”, “upper” or “lower” directly in contact with another component, but also the case that another component is disposed in between, unless otherwise specified. In addition, the fact that a component is “connected” to another component includes not only the case that it is directly connected to each other, but also the case that it is indirectly connected to each other, unless otherwise specified.

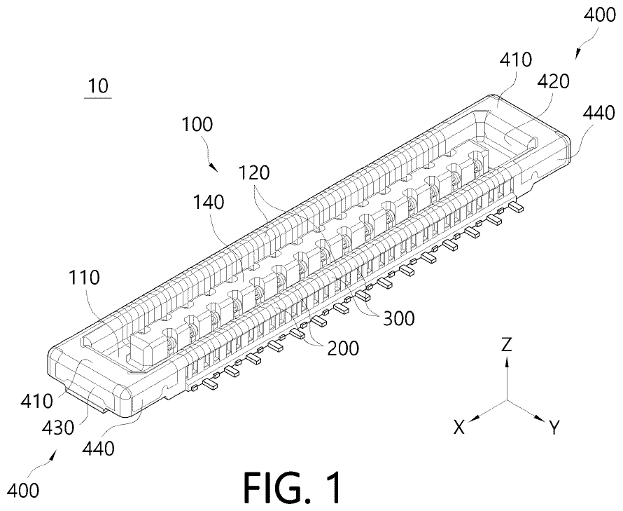

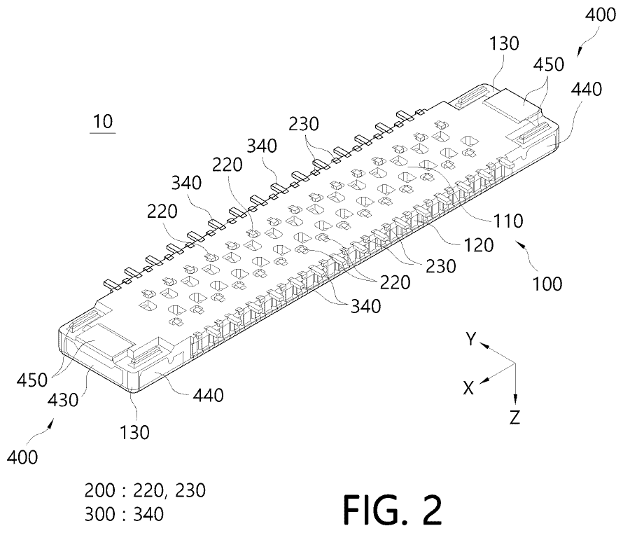

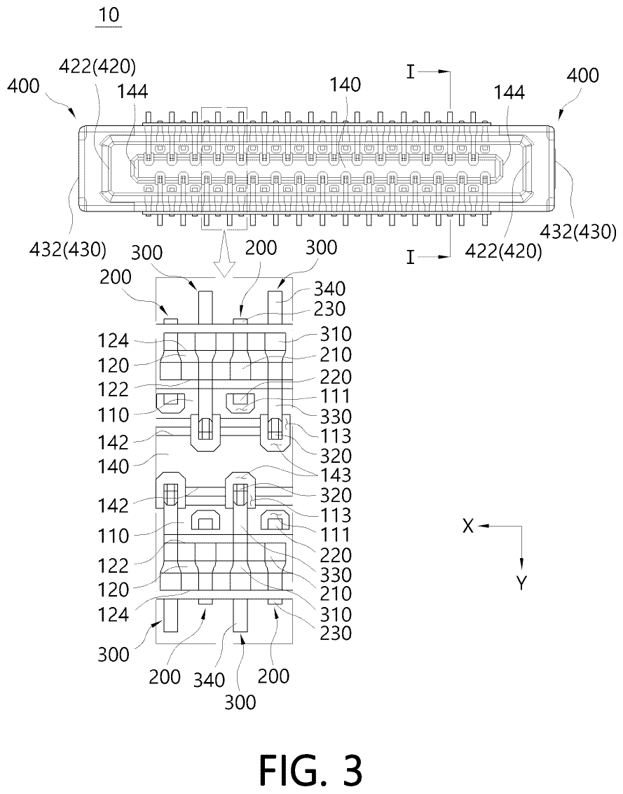

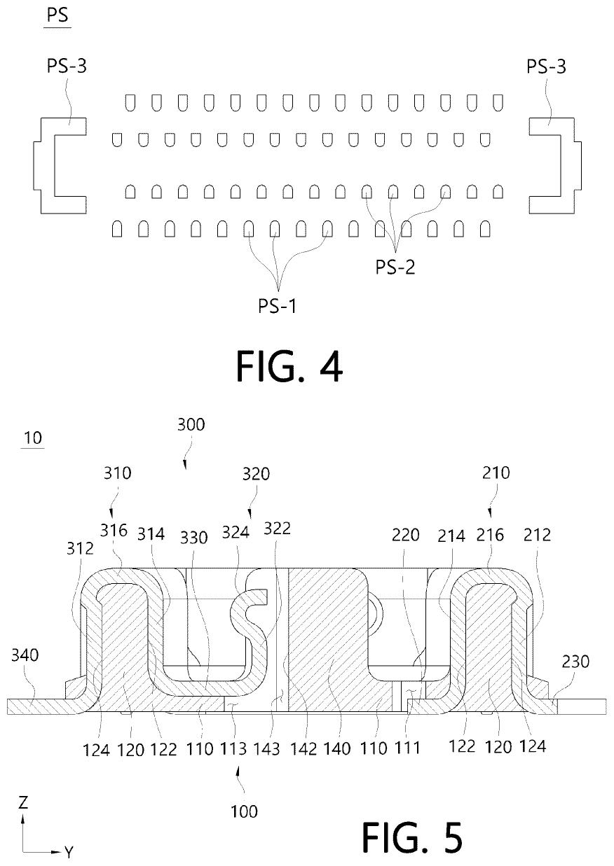

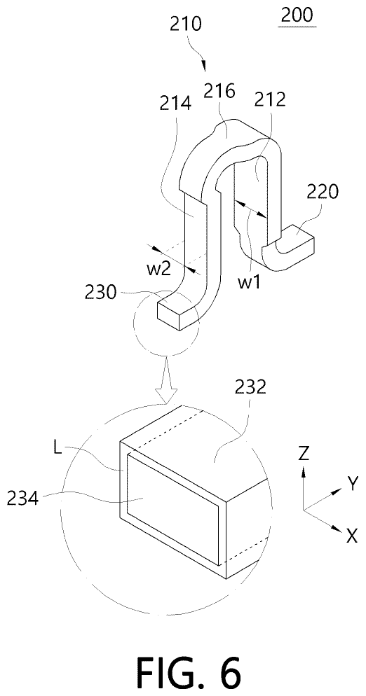

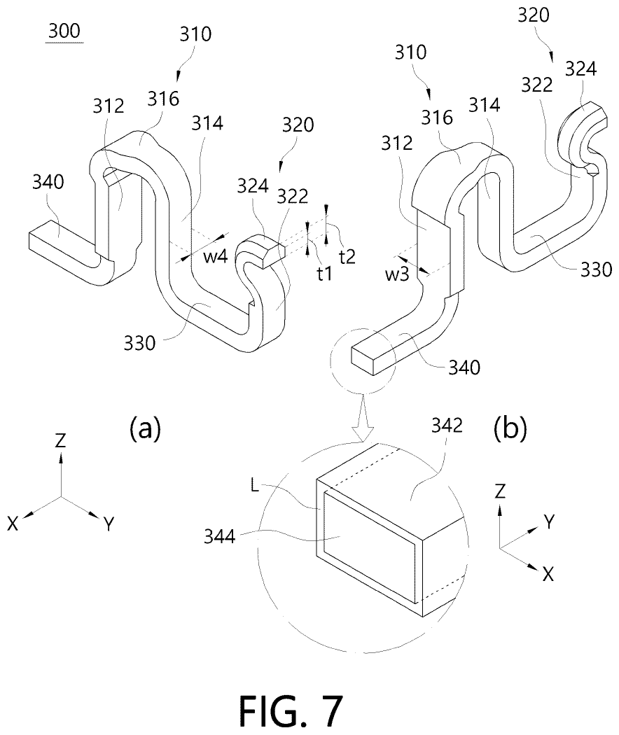

FIGS. 1 and 2 are perspective views of a connector according to an embodiment of the present disclosure viewed from different angles. FIG. 3 is a plan view of a connector according to an embodiment of the present disclosure. FIG. 4 is a plan view of a PCB pattern formed between a connector and a substrate according to an embodiment of the present disclosure. FIG. 5 is a cross-sectional view taken along the cutting line I-I of FIG. 3. FIG. 6 is a perspective view of a first contact of a connector according to an embodiment of the present disclosure viewed from above. FIG. 7(a) and 7(b) are perspective views of a second contact according to an embodiment of the present disclosure viewed from different angles.

Hereinafter, when viewed in the drawing, a first direction is defined as an X-axis direction, a second direction is defined as a Y-axis direction, and a third direction is defined as a Z-axis direction. Here, in the present specification, the first to third directions and the coordinate axes (XYZ axes) are only introduced to describe the relative positions between the components, and do not limit the absolute positions of each component.

In the present specification, extending in a predetermined direction means extending to have a length component along the direction. For example, extending in a direction inclined to the X-axis has a length component along a direction parallel to the X-axis, so extending in the X-axis includes extending along a direction inclined to the X-axis.

Referring to FIGS. 1 and 2, a connector according to an embodiment of the present disclosure may be a plug connector 10. The plug connector 10 may be mounted on a substrate (not shown) and may be shape-fitted with and coupled with another connector (for example, a receptacle connector 20 illustrated in FIG. 7) mounted on another substrate. Accordingly, an electric circuit of the substrate on which the plug connector 10 is mounted and the electric circuit of the other substrate on which another connector is mounted may be electrically connected (or energized) to each other.

According to the present embodiment, the plug connector 10 may include an insulating body 100, a first contact 200, a second contact 300, and a hold down structure 400. The insulating body 100 is configured to provide a base on which other components of the plug connector 10 may be disposed. In this case, the insulating body 100 may include a material having predetermined insulating properties in order to achieve electrical insulation with other components.

Referring to FIGS. 1 to 4, in the present embodiment, the insulating body 100 may include a bottom 110, an outer support wall 120, a hold down retaining wall 130, and an inner support wall 140.

According to the present embodiment, the bottom 110 may be provided as a flat plate-shaped member extending in the X-axis direction and having a predetermined width in the Y-axis direction. The back surface of the bottom 110 is placed on one surface of the substrate, thereby enabling the entire plug connector 10 to be supported.

In this case, according to the present embodiment, the bottom 110 may be provided with a hole-shaped inspection window 111 formed in the Z-axis direction. In the present embodiment, the inspection window 111 may be provided in plural corresponding to the plurality of first contacts 200.

In addition, some of the plurality of inspection windows 111 may be spaced apart from each other along the X-axis direction on one side of the pair of outer support walls 140. Similarly, the remaining portion of the plurality of inspection windows 111 may be spaced apart from each other along the X-axis direction on the other side of the outer support walls 140. That is, the plurality of inspection windows 111 may be formed in two rows along the X-axis direction in correspondence to the arrangement of the first contact 200 to be described later.

Through this, a first substrate mounter 220 of the first contact 200 coupled to the outer support wall 140 is observed through the inspection window 111, so that a mounting state between the first substrate mounter 220 and the substrate may be inspected.

In addition, as described later, since the second contacts 300 are disposed between the first contacts 200 adjacent to each other in the X-axis direction, a predetermined distance may be secured between the inspection windows 111 adjacent to the X-axis direction, thereby minimizing the weakness of the strength of the bottom 110 due to the formation of the inspection windows 111.

Meanwhile, in the present embodiment, each of the plurality of inspection windows 111 is configured to check one first substrate mounter 220, but they may be provided in a form that extends long in the X-axis direction so that two or more first substrate mounters 220 may be checked through one inspection window 111.

In addition, the bottom 110 according to the present embodiment may be provided with a corresponding concave groove 113 recessed in the Z-axis direction. The corresponding concave groove 113 may perform a function of relieving the constraint between the second contact 300 and the insulating body 100 so that the elastic contactor 320 of the second contact 300 may operate more smoothly.

To this end, the corresponding concave groove 113 according to the present embodiment may be provided in plural numbers corresponding to the number of second contacts 300. In addition, some of the plurality of second contacts 300 may be spaced apart from each other on one side of the inner support wall 140 to be described later along the X-axis direction, and the remaining portion may be spaced apart from each other on the other side of the inner support wall 140 along the X-axis direction. That is, the plurality of corresponding concave grooves 113 may be formed in two rows along the X-axis direction, corresponding to the arrangement of the second contacts 300 to be described later.

More specifically, in the present embodiment, the corresponding concave grooves 113 may be connected to concave grooves 143 of the inner support wall 140 to be described later. Through this, the corresponding concave groove 113 may expose a portion where a second central connector 330 and the elastic contactor 320 of the second contact 300 are connected to the outside (i.e., relieve constraint). Accordingly, the elastic contactor 320 of the second contact 300 may be easily elastically operated according to an external force.

In addition, as described later, since the first contact 200 is disposed between the second contacts 300 adjacent in the X-axis direction, a predetermined distance may be secured between the corresponding concave grooves 113 adjacent in the X-axis direction, thereby minimizing the weakening of the strength of the bottom 110 due to the formation of the corresponding concave grooves 113.

Meanwhile, the shape of the corresponding concave groove 113 is not particularly limited as long as it may provide a predetermined space so that the portion where the elastic contactor 320 and the second central connector 330 are connected is not sunken into the bottom 110.

Referring again to FIGS. 1 to 4, in the present embodiment, the outer support wall 120, the hold down retaining wall 130, and the inner support wall 140 may be provided on the upper side of the bottom 110. The outer support wall 120 may be configured to support the contacts 200 and 300 to be described later. To this end, the outer support wall 120 may protrude in the positive direction of the Z-axis from the upper surface of the bottom 110, and may extend long along the X-axis direction.

In this case, the outer support wall 120 according to the present embodiment may be provided in pairs and spaced apart from each other at a predetermined distance in the Y-axis direction. In other words, the pair of outer support walls 120 may be provided as a pair of rod-shaped members extending in parallel to each other in the X-axis direction.

Hereinafter, a side surface facing the inner support wall 140 to be described later among both side surfaces 122 and 124 of the outer support wall 120 in the Y-axis direction is referred to as a first side surface 122, and a side surface opposite the first side surface 122 is referred to as a second side surface 124.

Meanwhile, according to the present embodiment, the hold down retaining wall 130 may be provided on a side of the pair of outer support walls 120 in the X-axis direction. The hold down retaining wall 130 may increase the overall rigidity of the insulating body 100 by supporting the end of the outer support wall 120. Such a hold down retaining wall 130 may be provided in a pair and may be provided on both sides of the pair of outer support walls 120 in the X-axis direction.

In the present embodiment, the hold down retaining wall 130 may be provided as a block-shaped member extending in the Y-axis direction to connect the X-axis direction ends of the pair of outer support walls 120.

Referring again to FIGS. 1 to 4, the inner support wall 140 protruding in the positive direction of the Z-axis from the bottom 110 may be provided between the pair of outer support walls 120 according to the present embodiment. The inner support wall 140 may perform a function of increasing the coupling force of both connectors by shape-fitting with a part of another connector coupled to the plug connector 10.

In the present embodiment, the inner support wall 140 may be provided as a rod-shaped member extending parallel to the outer support wall 120. In this case, the inner support wall 140 may have a length slightly shorter than the outer support wall 120 in the X-axis direction. Accordingly, the inner support wall 140 may be surrounded by the pair of outer support walls 120 and the pair of hold down retaining walls 130.

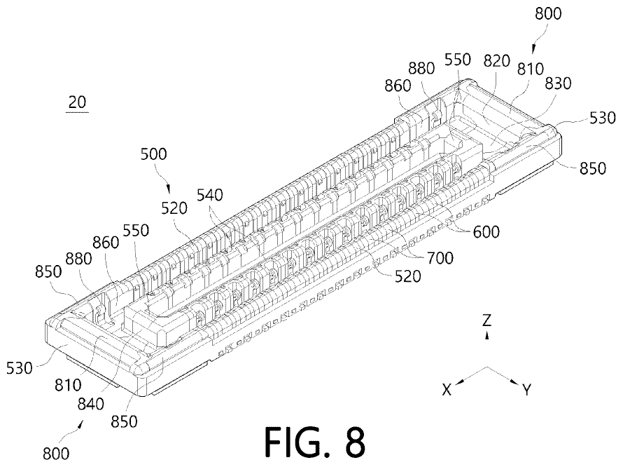

In the present embodiment, the inner support wall 140 may be configured to be coupled between a pair of inner support walls 540 (shown in FIG. 8) of other connectors, for example, the receptacle connector 20 (shown in FIG. 8) to be described later.

As an example, the inner support wall 140 may be coupled to a space between the pair of inner support walls 540 (shown in FIG. 8) of the receptacle connector 20 in shape-fitting manner. To this end, the inner support wall 140 may have a shape corresponding to the coupling space 511 of the receptacle connector 20 (shown in FIG. 8) to be described later.

Meanwhile, in the present embodiment, the concave groove 143 may be provided on the side surface 142 of the inner support wall 140 facing the Y-axis direction. The concave groove 143 may provide a space in which the elastic contactor 320 of the second contact 300 may be elastically operated and the elastic contactor 320 may be protected from the outside by the inner support wall 140.

To this end, the concave groove 143 may be provided in plural corresponding to the plurality of second contacts 300. In addition, some of the plurality of concave grooves 143 may be spaced apart from each other on one of the two side surfaces 142 along the X-axis direction, and remaining portion may be spaced apart from on the other side surfaces 142 along the X-axis direction. That is, the plurality of concave grooves 143 may be formed in two rows on both side surfaces 142 of the inner support wall 140 corresponding to the arrangement of the second contacts 300 to be described later.

In this case, in the present embodiment, as described later, since the first contact 200 is disposed between the second contacts 300 adjacent in the X-axis direction, a predetermined distance may be secured between the concave grooves 143 adjacent in the X-axis direction, so that the strength weakening of the inner support wall 140 due to the formation of the concave groove 143 may be minimized.

As shown, the concave groove 143 may be concavely formed inward of the inner support wall 140. In addition, the concave groove 143 extends in the Z-axis direction, and both side portions in the extending direction may be opened to the outside. However, the shape of the concave groove 143 is not particularly limited as long as it may provide an operative space in which the elastic contactor 320 may be elastically operated and protected.

Meanwhile, the above-described insulating body 100 may be integrally formed by injection molding, but is not limited thereto. In addition, a shape of the insulating body 100 is not particularly limited as long as it may provide a base to which other components may be installed, and may be variously modified as necessary, such as a portion thereof being formed to be curved.

Next, with reference to FIGS. 4 to 6, the first contact 200 and the second contact 300 of the plug connector 10 according to the present embodiment will be described. Referring to FIGS. 4 and 5, the first contact 200 according to the present embodiment may be provided as a fixed terminal having electrical conductivity and a curved metal pin shape. In this case, the first contact 200 according to the present embodiment may be provided in plural and may be spaced apart from each other on the pair of outer support walls 120 in the X-axis direction.

In the present embodiment, the first contact 200 may include a first outer coupler 210, a first substrate mounter 220, and a carrier connector 230. First, the first outer coupler 210 may include a first outer contact section 212, a first inner contact section 214, and a first outer coupling section 216, and may be coupled to the outer support wall 140 of the insulating body 100.

According to the present embodiment, the first outer contact section 212 may extend in the Z-axis direction. The first outer contact section 212 may then be coupled onto the second side surface 124 of the outer support wall 140 such that a portion of the side surface is exposed to the outside. Similarly, the first inner contact section 214 may extend in the Z-axis direction and may be coupled to the first side surface 122 of the outer support wall 120 so that a portion of the side surface is exposed to the outside.

As such, since the first contact 200 according to the present embodiment is configured such that the first inner contact section 214 and the first outer contact section 212 are exposed on both side surfaces of the outer support wall 120, it is possible to achieve and maintain dual contact with contacts of other connectors based on the supporting force of the outer support wall 120.

Next, in the present embodiment, the first outer connection section 216 may connect the upper end of the first inner contact section 214 and the upper end of the first outer contact section 212. In this case, the first outer connection section 216 may be coupled onto the upper surface of the outer support wall 120 so that the upper surface is exposed upward.

Meanwhile, in the present embodiment, the first substrate mounter 220 may be connected to the first inner contact section 214. The first substrate mounter 220 may extend from a lower end of the first inner connection section 214 toward the inner support wall 140.

As shown, the first substrate mounter 220 may extend along the Y-axis direction. However, if the end of the first substrate mounter 220 is configured to face the inner support wall 140, the extension direction of the first substrate mounter 220 is not particularly limited.

In this case, in the present embodiment, at least a portion of the first substrate mounter 220 may be disposed in the inspection window 111 so that it may be observed through the inspection window 111 of the above-described bottom 110. In the illustrated embodiment, an end of the first substrate mounter 220 is disposed in the inspection window 111.

Meanwhile, the first substrate mounter 220 may be configured to be mounted on a substrate on which the plug connector 10 is placed. For example, the first substrate mounter 220 may be mounted on the substrate by a soldering process or a welding process. In this case, a predetermined PCB pattern may be interposed between the first substrate mounter 220 and the substrate to couple them together.

Next, in the present embodiment, the carrier connector 230 may be connected to the first outer connection section 212. The carrier connector 230 may extend in the opposite direction to the first substrate mounter 220 from the lower end of the first outer connection section 212. In other words, the carrier connector 230 may extend to the outside of the insulating body 100.

As shown, the carrier connector 230 may extend along the Y-axis direction. However, if the end of the carrier connector 230 is configured to face a direction opposite to the end of the first substrate mounter 220, the extension direction of the carrier connector 230 is not particularly limited.

In this case, a predetermined plating layer L may be provided on the side surface 232 of the carrier connector 230 in the extending direction. Therefore, the side surface 232 may not be exposed to the outside. However, the extension end surface 234 of the carrier connector 230 may be configured to be exposed to the outside because the plating layer L is not provided.

This is because the carrier connector 230 according to the present embodiment may perform a function of connecting the carrier and the first contact 200, and in the manufacturing process of the plug connector 10, the carrier connector 230 may be cut to separate the first contact 200 and the carrier from each other.

In this case, the carrier may mean an intermediate material used to fix the contacts 200 and 300 in the manufacturing process of the plug connector 10. Accordingly, the end surface 234 of the carrier connector 230 may be formed as a cutting surface, and the plating layer L may not be provided on the end surface 234.

Meanwhile, referring again to FIG. 5, in the present embodiment, a width w1 of the first inner contact section 214 in the X-axis direction may be configured to be longer than a width w2 of the first outer contact section 212 in the X-axis direction. Accordingly, the first inner contact section 214 may be strongly coupled while being in contact with the outer support wall 120 through a wider area, and may be electrically connected (or energized) with the contact of another connector through a wider area.

Next, referring to FIGS. 4 and 6, in the present embodiment, the second contact 300 may be provided as a fully movable terminal having electrical conductivity and a curved metal pin shape. In this case, the second contact 300 may be provided in plural and the plurality of second contacts 300 may be disposed between the first contacts 200 adjacent to each other in the X-axis direction. In other words, the first contact 200 and the second contact 300 may be alternately disposed along the X-axis direction.

The second contact 300 according to the present embodiment may include a second outer coupler 310, an elastic contactor 320, a central connector 330, and a second substrate mounter 340. The second outer coupler 310 may include a second outer contact section 312, a second inner contact section 314, and a second outer connection section 316, and may be coupled with the outer support wall 120.

First, the second outer contact section 312 according to the present embodiment may extend in the Z-axis direction. In addition, the second outer contact section 312 may be coupled onto the second side surface 124 of the outer support wall 140 such that a portion of the side surface is exposed to the outside. Similarly, the second inner contact section 314 may extend in the Z-axis direction and be coupled onto the first side surface 122 of the outer support wall 140 such that a portion of the side surface is exposed to the outside.

As such, since the second contact 300 according to the present embodiment is coupled such that the second inner contact section 314 and the second outer contact section 312 are exposed on both side surfaces of the outer support wall 120, so it is possible to achieve and maintain dual contact with contacts of other connectors based on the supporting force by the outer support wall 120.

In addition, the second central connector 330 may be connected to a lower end of the second inner contact section 314. The second central connector 330 may extend in the Y-axis direction and be coupled onto the upper surface of the bottom 110. In this case, the second central connector 330 may be configured such that the top surface thereof is exposed to the upper side of the bottom 110, but is not limited thereto. This may serve as a portion that is electrically connected (or energized) with contacts of another connector.

Meanwhile, in the present embodiment, a width w3 of the second outer contact section 312 in the first direction may be configured to be longer than a width w4 of the second inner contact section 314 in the first direction. Accordingly, the second outer contact section 312 may be strongly coupled while being in contact with the outer support wall 120 through a wider area, and may be electrically connected (or energized) with the contact of another connector through a wider area.

Referring again to FIG. 3, considering the positional relationship between the first contact 200 and the second contact 300 described above, the second inner contact section 314 having a relatively narrow width w4 is disposed between the first inner contact sections 214 having a relatively wide width w1 on the first side 122 of the outer support wall 120. In addition, a second outer contact section 314 having a relatively wide width w3 is disposed between the first outer contact sections 212 having a relatively narrow width w2 on the second side 124 of the outer support wall 120.

In this way, in the connector according to the present embodiment, the first contact 200 and the second contact 300 having different widths are alternately arranged, and the distance between the contacts is constantly spaced. Accordingly, the connector may have uniform strength as a whole, and the strength of the connector may be improved.

In addition, in the present embodiment, the second central connector 330 of the second contact 300 is disposed between the inspection windows 111 adjacent in the X-axis direction. The strength of the portion between the adjacent inspection windows 111 may be reinforced by the second central connector 330.

In addition, a portion of the first contact 200 is disposed between the corresponding concave groove 113 and the concave groove 143 adjacent to each other in the X-axis direction. By the first contact 200, the strength of the portion between the corresponding concave groove 113 and the concave groove 143 adjacent to each other may be reinforced.

Next, in the second contact 300 according to the present embodiment, the elastic contactor 320 may be provided at the end of the second central connector 330 facing the inner support wall 140. The elastic contactor 320 may be configured as a free end to be elastically operated by an external force.

To this end, the elastic contactor 320 may include an elastic arm section 322 extending in the positive direction of the Z-axis from the end of the second central connector 330 and a contact arm section 324 provided at the end of the elastic arm section 322 in the extending direction. In addition, the elastic arm section 322 and the contact arm section 324 may be disposed in the concave groove 143 of the inner support wall 140.

In this case, in the present embodiment, the contact arm section 324 may have a shape curved toward the outer support wall 120. In addition, the contact arm section 324 may have a thickness t2 of the center thicker than a thickness t1 of both sides in the X-axis direction. In other words, the contact arm section 324 may further protrude in a direction in which the center portion is curved.

Accordingly, by contacting a portion of another connector that has been inserted between the inner support wall 140 and the outer support wall 120 while pressing, a steadier state of electrical connection (or energization) may be achieved and maintained.

Next, in the present embodiment, the second substrate mounter 340 may be connected to the lower end of the second outer contact section 312 of the second outer coupler 310. In this case, the second substrate mounter 340 may extend in a direction opposite to the first substrate mounter 220. In other words, the second substrate mounter 340 may extend outward of the insulating body 100. That is, in the present embodiment, the second substrate mounter 340 and the carrier connector 230 described above may extend in the same direction.

As shown, the second substrate mounter 340 may extend along the Y-axis direction. However, if the end of the second substrate mounter 340 is configured to face a direction opposite to the end of the first substrate mounter 220, the extension direction of the second substrate mounter 340 is not particularly limited.

As described above, in the present embodiment, since the first substrate mounter 220 of the first contact 200 and the second substrate mounter 340 of the second contact 300 extend in opposite directions to each other, the first substrate mounter 220 and the second substrate mounter 340 are maximally spaced apart from each other in the Y-axis direction, thereby securing insulation performance and preventing short between the first substrate mounter 220 and the second substrate mounter 340.

Further, mounters of the first contact 200 and the second contact 300 adjacent to each other are arranged in zigzag. Accordingly, the connector according to the present embodiment may have a smaller pitch than the connector according to the comparative example in which the mounters are arranged in a row in parallel. Here, the pitch means a distance between connectors adjacent to each other in the X-axis direction.

For example, the pitch of the connector according to the present embodiment may be equal to or less than half the pitch of the connector according to the comparative example. Therefore, even if the connector according to the present embodiment is mounted on the substrate according to the PCB pattern, occurrence of a short circuit between the PCB pattern bridge or the adjacent PCB pattern may be prevented.

Meanwhile, the second substrate mounter 340 may be configured to be mounted on the substrate on which the plug connector 10 is placed. For example, the second substrate mounter 340 may be mounted on the substrate by a soldering process, and through this, a predetermined PCB pattern may be interposed between the second substrate mounter 340 and the substrate to couple them.

FIG. 4 shows the PCB pattern PS between the plug connector and the substrate. Such a PCB pattern PS may include a first PCB pattern PS-1 between the second substrate mounter 340 and the substrate, a second PCB pattern PS-2 between the first substrate mounter 220 and the substrate, and a third PCB pattern PS-3 between the substrate mounter 450 of hold down and the substrate, which will be described later.

In this case, a predetermined plating layer L may be provided on a side surface 342 of the second substrate mounter 340 in the extension direction. Therefore, the side surface 342 may not be exposed to the outside. On the contrary, the extension end surface 344 of the second substrate mounter 340 may be configured to be exposed to the outside because the plating layer L is not provided.

This is because the second substrate mounter 340 may perform a function of connecting the carrier and the second contact 300 in the present embodiment, and in order to separate the second contact 300 and the carrier from each other in the manufacturing process of the plug connector 10, the second substrate mounter 340 may be cut. Accordingly, the end surface 344 of the second substrate mounter 340 may be formed as a cutting surface, and the plating layer L may not be provided.

Hereinafter, relative positional relationships between the first contact 200 and the second contact 300 of the plug connector 10 according to the present embodiment will be described in more detail with reference to FIGS. 1 to 3. In the present embodiment, the first contact 200 disposed on one of the pair of outer support walls 120 may be arranged in parallel with the second contact 300 disposed on the other outer support wall 120 in the Y-axis direction.

In other words, the first contact 200 disposed on one of the pair of outer support walls 120 may be arranged to be offset from the first contact 200 disposed on the other outer support walls 120 in the Y-axis direction.

Through such arrangement, the first substrate mounter 220 of the first contact 200 disposed on different outer support walls 120 may be spaced apart from each other in the X-axis direction as much as possible to secure insulating performance, and shorting between them others may be prevented. Accordingly, the pair of the outer support walls 120 and the contacts 200 and 300 provided therein may be located closer to the Y-axis direction, and thus the plug connector 10 may be configured to be more compact.

In addition, in the present embodiment, the carrier connector 230 of the first contact 200 and the second substrate mounter 340 of the second contact 300 adjacent in the X-axis direction extend to the outside of the insulating body 100, so that the first contact 200 and the second contact 300 adjacent in the X-axis direction may be connected to one carrier together.

Accordingly, the insulating body 100 may be formed at once by performing an insert injection process using a pair of carriers provided with the first contact 200 and the second contact 300, so the plug connector 10 according to the present embodiment may be easily and quickly manufactured through a simple process.

Referring again to FIGS. 1 to 3, the hold down structure 400 may be coupled to the hold down retaining wall 130 of the plug connector 10 according to an embodiment of the present disclosure.

In the present embodiment, the hold down structure 400 may perform a function of guiding the coupling of another connector coupled with the plug connector 10 and protecting the hold down retaining wall 130 of the insulating body 100 from external shock or contamination. To this end, the hold down structure 400 may be made of a metal having a predetermined rigidity.

In the present embodiment, the hold down structure 400 may include an upper surface protector 410, an inner surface protector 420, an outer surface protector 430, a side surface protector 440, and a hold down-side substrate mounter 450.

First, the upper surface protector 410 may be provided as a flat plate-shaped member extending in the X-axis direction and the Y-axis direction, and may be configured to cover the upper surface of the hold down retaining wall 130. In this case, the upper surface protector 410 may have a sufficient area to cover the entire top surface of the hold down retaining wall 130.

In addition, in the present embodiment, one side surface of both side surfaces in the X-axis direction of the hold down retaining wall 130 facing the inner support wall 140 may be covered and protected by a plate-shaped inner surface protector 420 extending from the upper surface protector 410 in the negative direction of the Z-axis. In this case, the inner surface protector 420 may extend to a length in which the end in the extending direction is adjacent to the bottom 110 so as to entirely protect the one side surface.

Next, in the present embodiment, the other side surface facing the one side surface among both side surfaces in the X-axis direction of the hold down retaining wall 130 may be configured to be covered and protected by a plate-shaped outer surface protector 430 extending from the upper surface protector 410 in the negative direction of the Z-axis. In this case, the outer surface protector 430 may extend sufficiently in the Y-axis direction and the Z-axis direction to protect the other side surface as a whole.

Next, in the present embodiment, both side surfaces of the hold down retaining wall 130 in the Y-axis direction may be configured to be covered and protected respectively by a pair of side surface protectors 440 extending from the upper surface protector 410 in the negative direction of the Z-axis and having a plate shape. In this case, the side protector 440 may extend sufficiently in the X-axis direction and the Z-axis direction to cover a significant portion of the side surface.

In the present embodiment, at least one of the inner surface protector 420, the outer surface protector 430, and the side surface protector 440 may be connected to the above-described hold down-side substrate mounter 450. The hold down-side substrate mounter 450 may be disposed to pass through the hold down retaining wall 130. As such, a portion of the hold down-side substrate mounter 450 is mounted on the hold down retaining wall 130, so that the hold down structure 400 and the hold down retaining wall 130 may be strongly coupled to each other.

In addition, in the present embodiment, at least a portion of the hold down-side substrate mounter 450 may be exposed in the lower direction (the negative direction of the Z-axis) of the hold down retaining wall 130. In addition, the exposed portion may be configured to be mounted on the substrate. Accordingly, the hold down structure 400 may more strongly support the insulating body 100 based on the coupling force with the substrate and reinforce the overall rigidity of the plug connector 10.

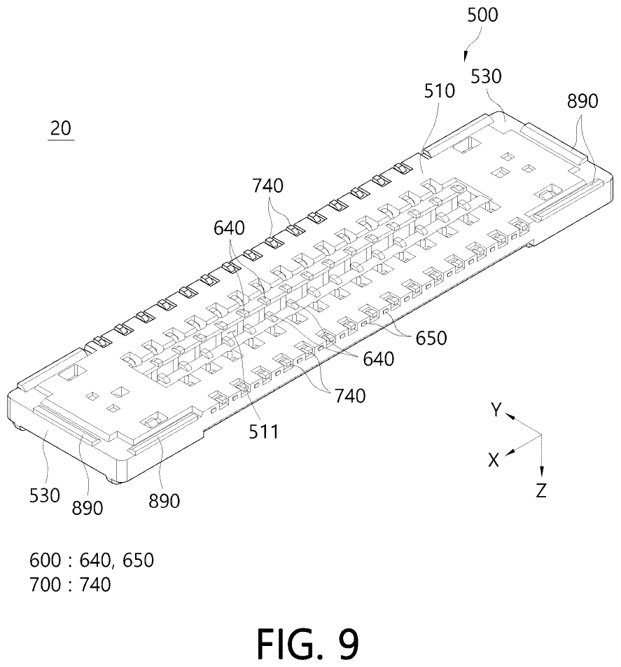

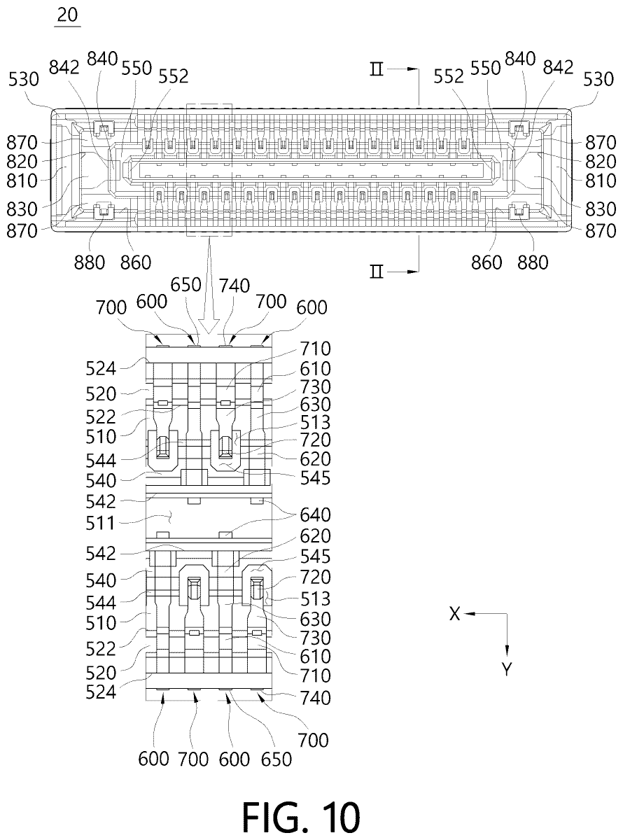

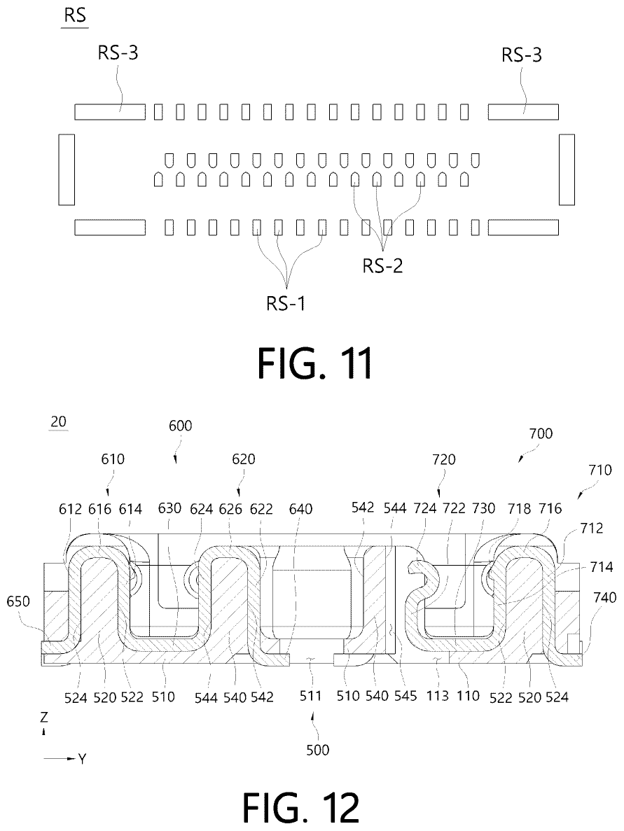

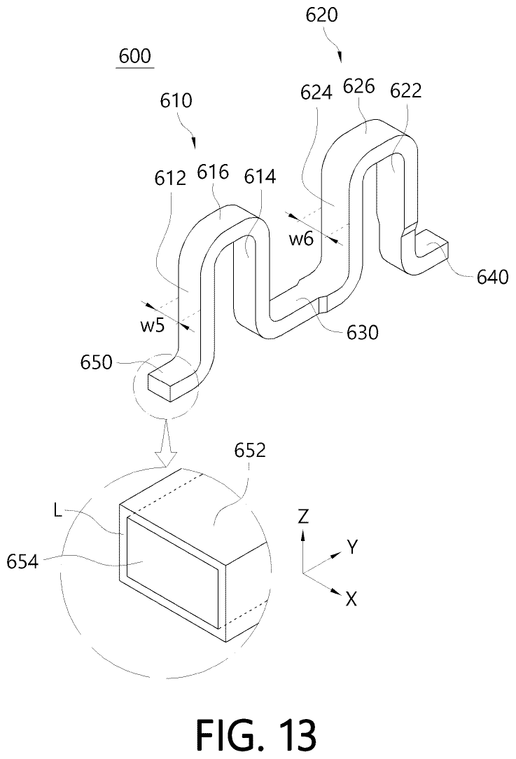

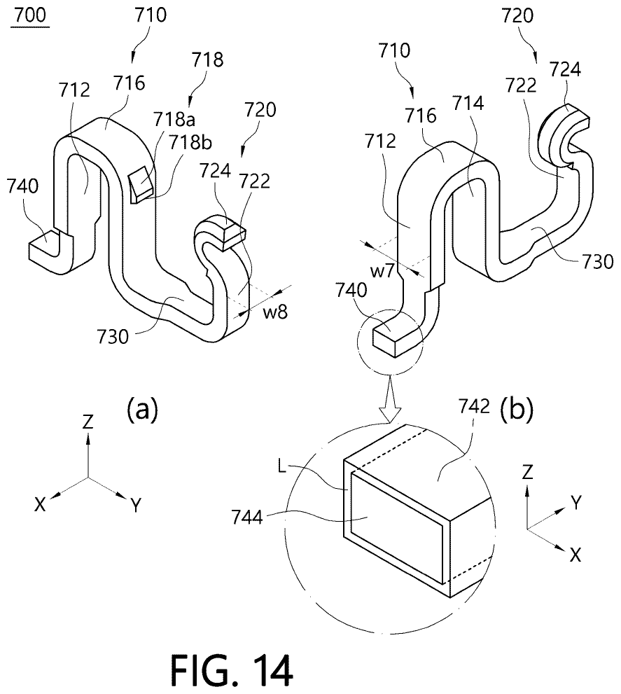

Hereinafter, a connector according to another embodiment of the present disclosure will be described with different drawings. FIGS. 8 and 9 are perspective views of a connector according to another embodiment of the present disclosure, viewed from different angles. FIG. 10 is a plan view of a connector according to another embodiment of the present disclosure. FIG. 11 is a plan view of a PCB pattern formed between a connector and a substrate according to another embodiment of the present disclosure. FIG. 12 is a cross-sectional view taken along the cutting line II-II of FIG. 10. FIG. 13 is a perspective view of a first contact of a connector according to another embodiment of the present disclosure, viewed from above. FIG. 14(a) and 14(b) are perspective views of a second contact according to another embodiment of the present disclosure, viewed from different angles.

Referring to FIGS. 7 to 9, a connector according to another embodiment of the present disclosure may be a receptacle connector 20. In this case, the receptacle connector 20 according to the present embodiment may be configured to be electrically connected (or energized) by being coupled with the plug connector 10 (shown in FIG. 1) in shape-fitting manner.

The receptacle connector 20 according to the present embodiment may include an insulating body 500, a first contact 600, a second contact 700, and a hold down structure 800. The insulating body 500 is configured to provide a base on which other components of the receptacle connector 20 may be disposed. In this case, the insulating body 500 may include a material having predetermined insulating properties in order to achieve electrical insulation with other components.

Referring to FIGS. 7 to 10, in the present embodiment, the insulating body 500 may include a bottom 510, an outer support wall 520, a hold down retaining wall 530, an inner support wall 540, and an inner wall 550.

First, the bottom 510 may be provided as a flat plate-shaped member extending in the X-axis direction and having a predetermined width in the Y-axis direction. The back surface of the bottom 510 may be configured to be placed on one surface of the substrate to support the receptacle connector 20 as a whole.

In this case, according to the present embodiment, a corresponding concave groove 513 recessed in the Z-axis direction may be provided. The corresponding concave groove 513 may be configured in a similar structure to perform the same function as the corresponding concave groove 113 (shown in FIG. 3) of the plug connector 10 (shown in FIG. 1).

Next, the outer support wall 520, the hold down retaining wall 530, the inner support wall 540, and the inner wall 550 may be provided on the upper side of the bottom 510 according to the present embodiment.

In this case, the outer support wall 520 and the hold down retaining wall 530 according to the present embodiment may be similar to perform the same function as the outer support wall 120 (shown in FIG. 1) and the hold down retaining wall 130 (shown in FIG. 1) of the plug connector 10 (shown in FIG. 1) described above.

Meanwhile, in the present embodiment, a pair of inner support walls 540 may be provided between a pair of outer support walls 520. The pair of inner support walls 540 may be provided as a pair of rod-shaped members extending in parallel to each other in the X-axis direction.

In this case, the pair of inner support walls 540 according to the present embodiment may be spaced apart by a predetermined distance in the Y-axis direction. Accordingly, a coupling space 511 may be provided between the pair of inner support walls 540. In the present embodiment, the coupling space 511 may be configured to allow the connector 20 and another connector to be coupled to each other by allowing a portion of another connector to enter.

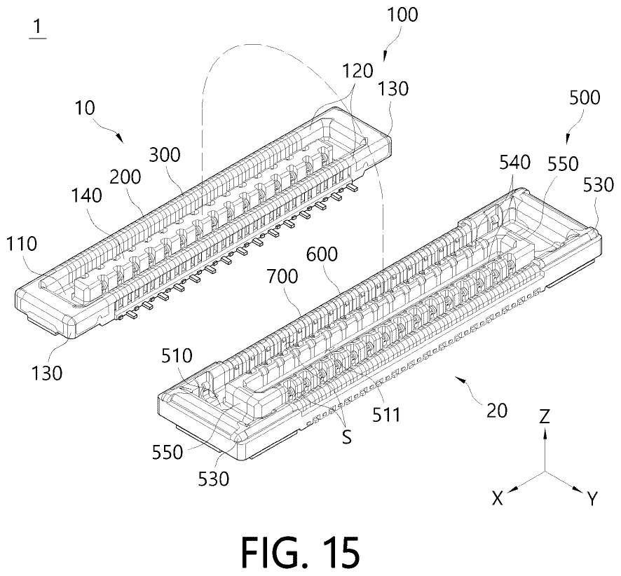

For example, the inner support wall 140 (shown in FIG. 1) of the plug connector 10 (shown in FIG. 1) described above may be coupled to the coupling space 511 of the connector 20. The coupling between these connectors will be described later with reference to FIGS. 15 to 18.

In this case, according to the present embodiment, the coupling space 511 may be formed to penetrate the bottom 510 of the insulating body 500. Accordingly, a first substrate mounter 640 of the first contact 600 to be described later may be observed through the coupling space 511. In other words, the coupling space 511 may function as an inspection window for the first substrate mounter 640.

This coupling space 511 may extend along the X-axis direction so as to allow observation of several first substrate mounters 640. Of course, the coupling space 511 may extend in the X-axis direction, but the portion of the coupling space 511 penetrating the bottom 510 may be formed only in a portion of the bottom 510, such as the inspection window 111 shown in FIG. 3.

In the following, among the Y-axis direction side surfaces 542 and 544 of the inner support wall 540, the side surface facing the adjacent inner support wall 540 is defined as a first side surface 542, and the side surface opposite the first side surface 542 is defined as a second side surface 544.

Meanwhile, a concave groove 545 may be provided on the second side 544 of the inner support wall 540. In this case, the concave groove 545 of the inner support wall 540 according to the present embodiment may be similarly configured to perform the same function as the concave groove 143 (shown in FIG. 3) of the plug connector 10 (shown in FIG. 1).

In addition, the inner wall 550 may be provided on the X-axis direction side of the pair of inner support walls 540. The inner wall 550 supports the end of the inner support wall 540 to increase the overall rigidity of the insulating body 500. Such an inner wall 550 may be provided in a pair and the pair of the inner walls 550 may be provided on each of both sides of the pair of inner support walls 540 in the X-axis direction.

In the present embodiment, the inner wall 550 may be provided as a block-shaped member extending in the Y-axis direction to connect the ends of the pair of inner support walls 540 in the X-axis direction to each other.

Next, referring to FIGS. 9 to 12, a first contact 600 and a second contact 700 of a receptacle connector 20 according to another embodiment of the present disclosure will be described.

A plurality of first contacts 600 according to the present embodiment may be provided and spaced apart from each other on the outer support wall 520 and the inner support wall 540 along the X-axis direction. In addition, the second contact 700 may be respectively disposed between the first contacts 600 adjacent in the X-axis direction.

In this case, relative positional relationships between the first contact 600 and the second contact 700 according to the present embodiment may be similarly configured to have the same effect as the first contact 200 (shown in FIG. 1) and the second contact 300 (shown in FIG. 1) of the plug connector 10 (shown in FIG. 1) described above.

Referring to FIGS. 10 and 11, the first contact 600 according to the present embodiment may include a first outer coupler 610, a first inner coupler 620, a first central connector 630, a first substrate mounter 640, and a carrier connector 650.

First, in the present embodiment, the first outer coupler 610 includes a first outer retaining section 612, a first outer contact section 614, and a first outer connection section 616, and may be coupled with the outer support wall 540 of the insulating body 500 so that at least a portion thereof is exposed to the outside.

In the present embodiment, the first outer retaining section 612 may extend in the Z-axis direction. In addition, the first outer retaining section 612 may be coupled onto the second side 524 of the outer support wall 520. In this case, the first outer retaining section 612 may be configured so that a portion, for example, an upper outer surface, is exposed to the outside, but is not limited thereto.

The first outer contact section 614 may extend in the Z-axis direction. In this case, the first outer contact section 614 may be coupled onto the second side surface 524 of the outer support wall 520 so that a portion of the side surface thereof is exposed to the outside.

Next, in the present embodiment, the first outer connection section 616 may connect an upper end of the first outer contact section 614 and an upper end of the first outer retaining section 612. In this case, the first outer connection section 616 may be coupled onto an upper surface of the outer support wall 520 so that an upper surface thereof is exposed upward, but is not limited thereto.

Meanwhile, the first inner coupler 620 of the first contact 600 according to the present embodiment includes a first inner holding portion 622, a first inner contact section 624, and a first inner connection portion 626, and at least a portion of the first inner coupler 620 may be coupled to the inner support wall 540 to be exposed to the outside.

First, in the present embodiment, the first inner retention portion 622 may extend in the Z-axis direction and be coupled to the first side 542 of the inner support wall 540. In this case, the first inner retention portion 622 may be configured so that the outer surface is exposed to the outside, but is not limited thereto.

The first inner contact section 624 may extend in the Z-axis direction. In this case, the first inner contact section 624 may be coupled onto the second side surface 544 of the inner support wall 540 so that a portion of the side surface thereof is exposed to the outside.

Next, in the present embodiment, the first inner connection section 626 may connect an upper end of the first inner contact section 624 and an upper end of the first inner retaining section 622. In this case, the first inner connection section 626 may be coupled onto an upper surface of the inner support wall 540 so that an upper surface thereof is exposed upward, but is not limited thereto.

As such, since the first contact 600 according to the present embodiment is configured such that the first outer contact section 614 and the first inner contact section 624 are exposed on the side surfaces 522 and 544 facing each other of the outer support wall 520 and the inner support wall 540, it is possible to achieve and maintain dual contact with contacts of other connectors based on the supporting forces of the outer support wall 520 and the inner support wall 540.

In this case, according to the present embodiment, a width w6 of the first inner coupler 620 in the X-axis direction may be configured to be longer than a width w5 of the first outer coupler 610 in the X-axis direction. Accordingly, the first inner coupler 620 may be strongly coupled while being in contact with the inner support wall 540 through a wider area, and may be electrically connected (or energized) with the contact of another connector through a wider area.

Referring again to FIGS. 10 and 11, in the present embodiment, a first central connector 630 connecting the first outer contact section 614 of the first outer coupler 610 and the first inner contact section 624 of the first inner coupler 620 may be provided. The first central connector 630 may extend in the Y-axis direction, and both ends in the extending direction may be connected to a lower end of the first outer contact section 614 and a lower end of the first inner contact section 624, respectively.

In addition, the first central connector 630 may be coupled with the bottom 510 of the insulating body 500. Here, the first central connector 630 may be configured such that the upper surface is exposed to the upper side of the bottom 510 to be electrically connected (or energized) with the contacts of other connectors, but is not limited thereto.

Meanwhile, in the present embodiment, the first substrate mounter 640 may be connected to the first inner coupler 620. The first substrate mounter 640 may be configured to be mounted on a substrate on which the receptacle connector 20 is placed. To this end, the first substrate mounter 640 may extend from the lower end of the first inner retaining section 622 of the first inner coupler 620 toward between the pair of inner support walls 540.

As shown, the first substrate mounter 640 may extend along the Y-axis direction, but if an end of the first substrate mounter 640 is directed between the pair of inner support walls 540, the extending direction of the first substrate mounter 640 is not particularly limited.

In this case, the first substrate mounter 640 may extend between the pair of inner support walls 540 of the insulating body 500. In this case, the first substrate mounter 640 may be disposed so that at least a portion thereof may be observed through the coupling space 511. Accordingly, the mounting state of the first substrate mounter 640 may be inspected.

Meanwhile, the carrier connector 650 may be connected to the first outer coupler 610. At this time, the carrier connector 650 according to the present embodiment may be similarly configured to perform the same function as the carrier connector 230 (shown in FIG. 4) of the plug connector 10 (shown in FIG. 1) described above.

Referring to FIGS. 10 and 12, the second contact 700 according to the present embodiment may include a second outer coupler 710, an elastic contactor 720, a second central connector 730, and a second substrate mounter 740. In addition, the second outer coupler 710 may include a second outer retaining section 712, a second outer contact section 714, a second outer connection section 716, and a contact protrusion section 718.

In the present embodiment, the second outer retaining section 712, the second outer contact section 714, the second outer connection section 716, the elastic contactor 720, the second central connector 730, and the second substrate mounter 740 may be similarly configured to perform the same functions as the second outer contact section 312 (shown in FIG. 4), the second inner contact section 314 (shown in FIG. 4), the second outer connection section 316 (shown in FIG. 4), the elastic contactor 320 (shown in FIG. 4), the second central connector 330 (shown in FIG. 4), and the second substrate mounter 340 (shown in FIG. 4) of the plug connector 10 (shown in FIG. 1).

In this case, according to the present embodiment, a width w7 of the second outer coupler 710 in the X-axis direction may be configured to be longer than a width w8 of the elastic contactor 720 in the X-axis direction. Accordingly, the second outer coupler 710 may be strongly coupled while being in contact with the outer support wall 520 through a wider area, and may be electrically connected (or energized) with the contacts of another connector through a wider area.

Referring again to FIG. 9, considering the positional relationship between the first contact 600 and the second contact 700 described above, the first outer coupler 610 having a relatively narrow width w5 is arranged in the X-axis direction between the second outer couplers 710 having a relatively wide width w7 on the outer support wall 520. In addition, the first inner coupler 620 having a relatively wide width w6 is arranged in the X-axis direction between the elastic contactors 720 having a relatively narrow width w8 on the inner support wall 540.

In this way, in the connector according to the present embodiment, the first contact 600 and the second contact 700 having different widths are alternately disposed, and the distance between the contacts is constantly spaced. Accordingly, the connector may have uniform strength as a whole, and the strength of the connector may be improved.

Furthermore, in the present embodiment, the first inner coupler 620 of the first contact 600 is disposed between the corresponding concave groove 513 and the concave groove 545 adjacent to each other in the X-axis direction. By the first inner coupler 620, the strength of the portion between the corresponding concave groove 513 and the concave groove 545 adjacent to each other may be reinforced.

In addition, considering the positional relationship between the first contact 600 and the second contact 700 described above, in the present embodiment, since the first outer coupler 610 having a relatively narrow width w5 is arranged in the X-axis direction between the second outer coupler 710 having a relatively wide width w7 on the outer support wall 520, and the first inner coupler 620 having a relatively wide width w6 is arranged in the X-axis direction between the elastic contactor 720 having a relatively narrow width w8 on the inner support wall 540, so the first contact 600 and the second contact 700 may be strongly coupled onto the outer support wall 520 and the inner support wall 540 at a high density.

Meanwhile, the contact protrusion section 718 according to the present embodiment may protrude between the outer support wall 520 and the inner support wall 540 from the side of the second outer contact section 714. Such a contact protrusion section 718 is configured so that other connectors entering between the outer support wall 520 and the inner support wall 540 may be locked and fixed, so that stable connection (or contact) of the two connectors may be realized. In this case, the contact protrusion section 718 may be disposed adjacent to the second outer connection section 716.

In the present embodiment, the contact protrusion section 718 may include a first protrusion surface 718a whose height away from the second outer contact section 714 increases as it goes in the negative direction of the Z-axis, and a second protrusion surface 718b whose height away from the second outer contact section 714 decreases as it goes in the negative direction of the Z-axis. In this case, the second protrusion surface 718b is configured to be further inclined with respect to the second outer contact section 714 than the first protrusion surface 718a, so that the above-described locking function may be effectively performed.

Meanwhile, FIG. 11 shows a PCB pattern RS between the receptacle connector and the substrate. These PCB patterns RS may include a first PCB pattern RS-1 between the second substrate mounter 740 and the substrate, a second PCB pattern RS-2 between the first substrate mounter 640 and the substrate, and a third PCB pattern RS-3 between the hold down-side substrate mounter 890 and the substrate, which will be described later.

Referring again to FIGS. 7 to 9, the hold down structure 800 may be coupled to the insulating body 500 of the receptacle connector 20 according to the present embodiment. The hold down structure 800 may be provided in a pair and may be respectively coupled to both sides of the insulating body 500 in the X-axis direction.

In the present embodiment, the hold down structure 800 may include an outer wall upper surface protector 810, an outer wall inner surface protector 820, a central-side bottom protector 830, an inner wall outer surface protector 840, an outer support wall upper surface protector 850, an outer support wall inner surface protector 860, a side-side bottom protector 870, a locking protrusion 880, and a hold down-side substrate mounter 890.

In the present embodiment, the outer wall upper surface protector 810, the outer wall inner surface protector 820, the inner wall outer surface protector 840, the outer support wall upper surface protector 850, and the outer support wall inner surface protector 860 may be provided as a plate-shaped member configured to cover and protect an upper surface of the hold down retaining wall 530 facing the positive direction of the Z-axis, a side surface of the hold down retaining wall 530 facing the inner support wall 540, a side surface of the inner wall 550 facing the outside of the first inner space S1, an upper surface of the outer support wall 520 facing the positive direction of the Z-axis, and a side surface of the outer support wall 520 facing the inner support wall 540.

In this case, the outer wall upper surface protector 810, the outer wall inner surface protector 820, the inner wall outer surface protector 840, the outer support wall upper surface protector 850, and the outer support wall inner surface protector 860 may extend in a predetermined direction to cover the entirely protected surface, and a portion thereof may include a curved surface as needed.

Referring to FIG. 9, in the present embodiment, the upper surface of the bottom 510 provided between the hold down retaining wall 530 and the inner wall 550 may be covered and protected by a pair of side-side bottom protection 870 symmetrically provided on the central-side bottom protector 830 and both sides of the central-side bottom protector 830 in the Y-axis direction.

In this case, the central-side bottom protector 830 and the side-side floor protector 870 may be provided as a plate-shaped member so as to cover the central portion and both side portions of the upper surface of the bottom 510 when viewed in the Y-axis direction.

In this case, in the present embodiment, a locking protrusion 880 protruding in the positive direction of the Z-axis may be provided on the side of the side-side bottom protector 870 in the Y-axis direction. In this case, the locking protrusion 880 may be configured to elastically operate (or move) in the Y-axis direction.

This locking protrusion 880 may elastically support and fix a portion of another connector inserted between the hold down retaining wall 530 and the inner wall 550. In this case, in order to smoothly operate the locking protrusion 880, a predetermined groove or hole may be formed in the side surface of the outer support wall 520 and the outer support wall inner surface protector 860 to provide a space in which the locking protrusion 880 may be operated (or moved).

Referring again to FIG. 8, the hold down-side substrate mounter 890 of the hold down structure 800 according to the present embodiment may be configured to have a structure and function similar to the hold down-side substrate mounter 450 of the hold down structure 400 of the plug connector 10 described above.

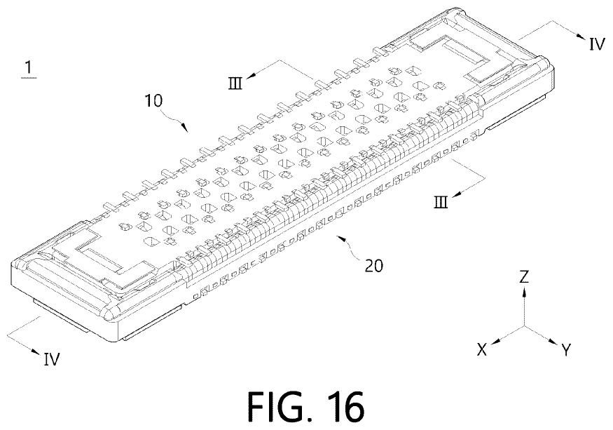

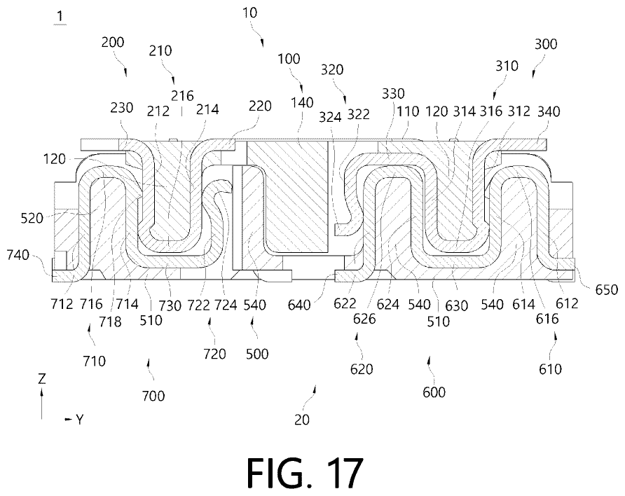

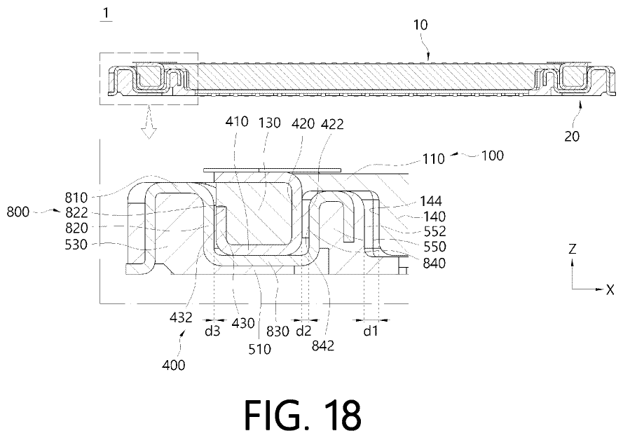

Hereinafter, a connector assembly according to an embodiment of the present disclosure will be described with different drawings. FIG. 15 is an exploded perspective view of a connector assembly according to an embodiment of the present disclosure. FIG. 16 is a perspective view of a connector assembly according to an embodiment of the present disclosure, viewed from above. FIG. 17 is a cross-sectional view taken along the cutting line III-III of FIG. 16. FIG. 18 is a cross-sectional view taken along the cutting line IV-IV of FIG. 16.

Referring to FIGS. 13 and 14, a connector assembly 1 according to an embodiment of the present disclosure may be formed by two connectors being coupled in a shape-fitting manner to each other. In this case, in the present embodiment, the two connectors may be each a plug connector 10 according to an embodiment of the present disclosure and a receptacle connector 20 according to another embodiment of the present disclosure, but the present disclosure is not limited thereto.

In the present embodiment, the inner support wall 140 of the plug connector 10 may enter the coupling space 511 provided between the pair of inner support walls 540 of the receptacle connector 20. The outer support wall 120 of the plug connector 10 may enter a predetermined space S provided between the outer support wall 520 and the inner support wall 540 of the receptacle connector 20.

In addition, the hold down retaining wall 130 of the plug connector 10 may enter between the inner wall 550 and the hold down retaining wall 530 of the receptacle connector 20. In the above process, the hold down structures 400 and 800 may protect the hold down retaining walls 130 and 530 and the bottoms 110 and 510 and perform a function of guiding the coupling of both connectors 10 and 20.

As such, the connector assembly 1 according to the present embodiment is configured such that the plug connector 10 has the inner support wall 140 and the inner support wall 140 is coupled to the coupling space 511 of the receptacle connector 20 in a shape-fitting manner, thereby increasing the coupling force between both connectors 10 and 20 and reinforcing the overall rigidity of the connector assembly 1.

Referring to FIG. 15, as shown, the second outer contact section 312 of the second contact 300 of the plug connector 10 may be electrically connected (or energized) with the first outer contact section 614 of the first contact 600 of the receptacle connector 20.

In addition, the second inner contact section 314 of the second contact 300 of the plug connector 10 may be electrically connected (or energized) with the first inner contact section 624 of the first contact 600 of the receptacle connector 20.

In addition, the elastic contactor 320 of the second contact 300 of the plug connector 10 may be elastically operated and electrically connected (or energized) with the first inner retaining section 622 of the first contact 600 of the receptacle connector 20 as the elastic contactor 320 is pressed by the inner support wall 540 of the receptacle connector 20 entering between the outer support wall 120 and the inner support wall 140.

As such, the plug connector 10 and the receptacle connector 20 according to the present embodiment may be in contact with each other in various locations and maintain a stable electrical connection (or contact).

Similarly, the second outer contact section 714 of the second contact 700 of the receptacle connector 20 may be electrically connected (or energized) with the first outer contact section 212 of the first contact 200 of the plug connector 10.

In addition, the elastic contactor 720 of the second contact 700 of the receptacle connector 20 may be elastically operated and electrically connected (or in contact) with the first inner contact section 214 of the first contact 200 of the plug connector 10 as the elastic contactor 720 is pressed by the outer support wall 520 of the plug connector 10 entering between the outer support wall 520 and the inner support wall 540.

In particular, the outer support wall 120 of the plug connector 10 and the first outer coupler 210 coupled thereto are locked and fixed between the contact protrusion section 718 of the second contact 700 of the receptacle connector 20 and the elastic coupler 720, thereby realizing a more stable connection (or contact).

Meanwhile, referring to FIG. 16, as described above, the hold down retaining wall 130 of the plug connector 10 may be coupled to the hold down retaining wall 530 and the inner wall 550 of the receptacle connector 20 in a shape-fitting manner.

More specifically, in the present embodiment, an end surface 144 in the extending direction of the inner support wall 140 of the plug connector 10 and one side surface 552 in the X-axis direction of the inner wall 550 of the receptacle connector 20 may be arranged to face each other.

In addition, an outer surface 842 in the X-axis direction of the inner wall outer surface protector 840 of the receptacle connector 20 and an outer surface 422 in the X-axis direction of the inner surface protector 420 of the plug connector 10 may be arranged to face each other.

In this case, the outer surface 842 of the inner wall outer protector 840 may mean a surface facing the negative direction of the X-axis so as to protect the other side surface in the X-axis direction of the inner wall 550 of the receptacle connector 20, and the outer surface 422 of the inner protector 420 may mean a surface facing the positive direction of the X-axis so as to protect the one side surface in the X-axis direction of the hold down retaining wall 130 of the plug connector 10.

In addition, the outer surface 822 of the outer wall inner surface protector 820 of the receptacle connector 20 in the X-axis direction and the outer surface 432 of the outer surface protector 430 of the plug connector 10 in the X-axis direction may be arranged to face each other.

In this case, the outer surface 822 of the outer wall inner surface protector 820 may mean a surface facing the positive direction of the X-axis so as to protect the one side surface in the X-axis direction of the hold down retaining wall 530 of the receptacle connector 20, and the outer surface 432 of the outer protector 430 may mean a surface facing the negative direction of the X-axis so as to protect the other side surface in the X-axis direction of the hold down retaining wall 130 of the plug connector 10.

Meanwhile, in the present embodiment, the X-axis direction distance d1 (hereinafter referred to as a first distance) between the end surface 144 in the extending direction of the inner support wall 140 of the plug connector 10 and the one side surface 552 of the inner wall 550 of the receptacle connector 20 may be configured to be longer than the X-axis direction distance d2 (hereinafter referred to as a second distance) between the outer surface 842 of the inner wall outer protector 840 of the receptacle connector 20 and the outer surface 422 of the inner wall protector 420 of the plug connector 10.

In addition, in the present embodiment, the second distance d2 may be configured to be longer than the X-axis direction distance d3 (hereinafter referred to as a third distance) between the outer surface 822 of the outer wall inner protector 820 of the receptacle connector 20 and the outer surface 432 of the outer protector 430 of the plug connector 10.

In other words, the first to third distances d1 to d3 may follow Equation 1 below.

first distance d1>second distance d2>third distance d3 [Equation 1]

This distance (or tolerance) is to guide the shape-fitting coupling of the plug connector 10 and the receptacle connector 20 by the interaction between the hold down structure 400 of the plug connector 10 and the hold down structure 800 of the receptacle connector 20 and to prevent the inner support wall 140 of the plug connector 10 and the inner wall 550 of the receptacle connector 20 from interfering with each other and being damaged.

This is because, if the first distance d1 is configured to be shorter than the second distance d2 or the third distance d3, there is a high possibility that the inner support wall 140 of the plug connector 10 and the inner wall 550 of the receptacle connector 20 may interfere with each other and be damaged during the process of coupling the two connectors 10 and 20.

Furthermore, one purpose of the connector assembly 1 is to implement ultra-thin pitch, which requires that the long direction (the X-axis direction in the drawing) clearance of the connector is small after the plug connector 10 and the receptacle connector 20 are coupled, and that damage should be prevented during the coupling process of both connectors 10 and 20.

To this end, in the present embodiment, the gap (i.e., the third distance d3) between the outer wall inner surface protector 820 of the receptacle connector 20 and the outer surface protector 430 of the plug connector 10 having a relatively strong strength may be set to the smallest according to Equation 1, and the gap (i.e., the first distance d1) between the inner wall 550 of the receptacle connector 20 and the inner support wall 140 of the plug connector 10 having a relatively weak strength may be set to the largest. Accordingly, damage caused by interference between the weak portions may be prevented.

Although the present disclosure has been described above, the spirit of the present disclosure is not limited to the embodiments presented in this specification, and those skilled in the art who understand the spirit of the present disclosure may easily propose other embodiments within the same scope of the spirit of the present disclosure by adding, changing, deleting, and adding components, but this is also within the scope of the spirit of the present disclosure.

1. A receptacle connector comprising:
an insulating body configured to be placed on a substrate, including:
a flat plate-shaped bottom,
a pair of outer support walls configured to protrude from the bottom and extend in parallel to each other in a first direction (X-axis direction), and
a pair of inner support walls configured to extend in parallel between the pair of outer support walls;
a plurality of first contacts configured to be disposed apart from each other along the first direction (X-axis direction) on each of the pair of outer support walls; and
a plurality of second contacts each configured to be respectively disposed between the first contacts adjacent to each other in the first direction (X-axis direction) among the plurality of first contacts,
wherein the pair of inner support walls are configured to be spaced apart each other in a second direction (Y-axis direction) so that a coupling space for receiving a portion of another connector is provided between the pair of inner support walls.

2. The receptacle connector of claim 1, wherein the insulating body includes:
an inner wall configured to be provided at each of one end of the pair of inner support walls in an extension direction and connect the one ends of the pair of inner support walls to each other, and
wherein the inner wall is configured to be provided in a pair and the pair of the inner walls are configured to be respectively disposed at both ends of the pair of inner support walls in the extension direction.

3. The receptacle connector of claim 1, wherein each of the first contacts is configured to be provided as a fixed terminal, including:
a first outer coupler configured to be coupled to the outer support wall so that at least a portion thereof is exposed to the outside,
a first inner coupler configured to be connected to the first outer coupler and be coupled to the inner support wall so that at least a portion thereof is exposed to the outside, and
a first substrate mounter configured to extend from one side of the first inner coupler to a space between the pair of inner support walls and be mounted on the substrate, wherein each of the second contacts is configured to be provided as a movable terminal, including:
a second outer coupler configured to be coupled to the outer support wall so that at least a portion thereof is exposed to the outside, and
an elastic contactor configured to extend from one side of the second outer coupler onto a side surface of the inner support wall and have a free end to be elastically operated by being pressurized by an external force.

4. The receptacle connector of claim 3, wherein each of the first contacts includes:
a carrier connector configured to extend in a direction opposite to the first substrate mounter from the first outer coupler, and
wherein the carrier connector includes a plating layer L so that a side surface in the extension direction is configured to be not exposed to the outside, and an end surface the extension direction is configured to be exposed to the outside.

5. The receptacle connector of claim 3, wherein each of the second contacts includes:
a second substrate mounter configured to extend from the other side of the second outer coupler in a direction opposite to the first substrate mounter and be mounted on the substrate.

6. The receptacle connector of claim 3, wherein the coupling space is configured to penetrate the bottom so that the first substrate mounter may be observed through the coupling space.

7. The receptacle connector of claim 6, wherein the coupling space is configured to extend along the first direction X-axis direction so that at least two of the first substrate mounters may be observed.

8. A plug connector for being coupled with the receptacle connector of claim 1, comprising:
an insulating body configured to be placed on a substrate, including:
a flat plate-shaped bottom,
a pair of outer support walls configured to protrude from the bottom and extend in parallel to each other in a first direction (X-axis direction), and
an inner support wall configured to extend in parallel between the pair of outer support walls;
a plurality of first contacts configured to be disposed apart from each other along the first direction (X-axis direction) on each of the pair of outer support walls; and
a plurality of second contacts configured to be respectively disposed between the first contacts adjacent to each other in the first direction (X-axis direction) among the plurality of first contacts,
wherein the inner support wall is configured to have a shape to be inserted into the coupling space of the receptacle connector so as to be coupled between the pair of inner support walls of the receptacle connector.

9. The plug connector of claim 8, wherein each of the first contacts is configured to be provided as a fixed terminal, including:
a first outer coupler configured to be coupled to the outer support wall so that at least a portion thereof is exposed to the outside, and
a first substrate mounter configured to extend from one side of the first outer coupler to the inner support wall and be mounted on the substrate,
wherein each of the second contacts configured to be provided as a movable terminal, including:
a second outer coupler configured to be coupled to the outer support wall so that at least a portion thereof is exposed to the outside, and
an elastic contactor configured to extend from one side of the second outer coupler onto a side surface of the inner support wall and have a free end to be elastically operated by being pressurized by an external force.

10. The plug connector of claim 9, wherein the first outer coupler includes:
a first inner contact section configured to be coupled onto a first side surface facing the inner support wall among both side surfaces and of the outer support wall so that at least a portion thereof is exposed to the outside;
a first outer contact section configured to be coupled onto a second side surface opposite the first side surface among both side surfaces and of the outer support wall so that at least a portion thereof is exposed to the outside; and
a first outer connection section configured to connect the first inner contact section and the first outer contact section,
wherein the first substrate mounter is configured to extend from the first inner contact section.

11. The plug connector of claim 10, wherein the first substrate mounter is configured to be at least partially exposed to the outside of the bottom, and
the bottom is configured to be provided with an inspection window for viewing the exposed portion of the first substrate mounter to the outside of the bottom.

12. The plug connector of claim 10, wherein each of the first contacts includes a carrier connector configured to extend in a direction opposite to the first substrate mounter from the first outer contact section, and wherein the carrier connector includes a plating layer L so that a side surface in the extension direction is configured to be not exposed to the outside, and an end surface in the extension direction is configured to be exposed to the outside.

13. The plug connector of claim 9, wherein each of the second contacts includes:
a second substrate mounter configured to extend from the other side of the second outer coupler in a direction opposite to the first substrate mounter and be coupled with the substrate.

14. The plug connector of claim 9, wherein the side surface of the inner support wall is configured to be provided with a concave groove recessed inwardly to provide a space in which the elastic contactor may elastically operate.

15. The plug connector of claim 9, wherein the first contacts provided on one of the pair of outer support walls and the second contacts provided on the other of the pair of outer support walls are arranged in parallel to each other in a direction in which the pair of outer support walls is arranged (Y-axis direction).

16. A connector assembly used with a plug connector and a receptacle connector coupled to each other,
wherein the plug connector comprises:
a first insulating body including:
a first bottom having a flat-plate shape,
a pair of first outer support wall configured to protrude from the first bottom and extend in parallel to each other along a first direction (X-axis direction),
a pair of first hold down retaining walls configured to be provided at both ends of the pair of first outer support walls in the extension direction, respectively, and
a first inner support walls configured to extend in parallel between the pair of first outer support walls; and
a plurality of contacts and configured to be spaced apart from each other along the first direction (X-axis direction) on each of the pair of first outer support walls,
wherein the receptacle connector comprises:
a second insulating body including:
a second bottom configured to be spaced apart from the first bottom to face each other,
a pair of second outer support wall configured to protrude from the second bottom and extend in parallel to each other along the first direction (X-axis direction),
a pair of second hold down retaining walls configured to be provided at both ends of the pair of second outer support wall in the extension direction, respectively,
a pair of second inner support wall configured to extend in parallel between the pair of second outer support wall and be provided with a coupling space therebetween, and
a pair of second inner walls configured to be provided at both ends of the pair of second inner support walls in the extension direction, respectively; and
a plurality of contacts and configured to be spaced apart from each other along the first direction (X-axis direction) on each of the pair of outer support walls, respectively,
wherein the coupling of the plug connector and the receptacle connector is configured to be achieved by the first inner support wall of the plug connector entering the coupling space of the receptacle connector.

17. The connector assembly of claim 16, wherein the plug connector includes:
a first hold down structure configured to cover both side surfaces of the first hold down retaining wall, and
wherein the receptacle connector includes:
a second hold down structure covering one side surface facing the second inner wall among both side surfaces of the second hold down retaining wall and one side surface facing the one side surface of the second hold down retaining wall among both side surfaces of the second inner wall.

18. The connector assembly of claim 17, wherein a first direction (X-axis direction) distance d1 between an end surface of the first inner support wall in the X-axis direction and one side surface of the second inner wall facing the end surface is configured to be longer than a first direction (X-axis direction) distance d2 between one side surface 422 facing the second inner wall among both side surfaces of the first direction (X-axis direction) of the first hold down structure and one side surface of the second hold down structure facing the one side surface of the first hold down structure.

19. The connector assembly of claim 18, wherein a first direction (X-axis direction) distance d2 between the one side surface of the first hold down structure and the one side surface of the second hold down structure is configured to be longer than a first direction (X-axis direction) distance d3 between the other side surface facing the one side surface of the first hold down structure and the other side surface of the second hold down structure facing the other side surface of the first hold down structure.
